(19) United States
(12) Patent Application Publication
(10) Pub. No.: US 2018/0272566 A1
(43) Pub. Date: Sep. 27, 2018

(54) CLOSED IMPREGNATION PROCESS AND APPARATUS THEREFOR

(71) Applicant: Dow Global Technologies LLC, Midland, MI (US)

(72) Inventors: Kevin J. Meyer, Houston, TX (US); Douglas L. Potts, Clute, TX (US); Todd Werth, Sebewaing, MI (US)

(21) Appl. No.: 15/762,396

(22) PCT Filed: Sep. 20, 2016
(86) PCT No.: PCT/US2016/052570

§ 371 Date: Mar. 22, 2018

Related U.S. Application Data
(60) Provisional application No. 62/221,654, filed on Sep. 22, 2015.

(51) Int. Cl. B29B 15/14; B29B 15/12; B29C 70/30

(52) U.S. Cl. CPC B29B 15/14; B29K 2075/00; B29C 70/30; B29B 15/122

(57) ABSTRACT

A closed impregnation device (200) for impregnating a fiber reinforcement material with a thermosetting resin composition including a housing, an entry means adapted for feeding a dry fiber reinforcement material into the housing, a means for feeding a dry fiber reinforcement material through, and into, the housing, a passageway from the entry means into the housing, an injection means disposed in the housing adapted for injecting a thermosetting resin composition into the housing and contacting and wetting the dry fiber reinforcement material, a means for feeding a thermosetting resin composition through, and into, the housing via the injection means, an exit means adapted for discharging a wetted fiber reinforcement material from the housing, and a passageway from the inside of the housing to the outside of the housing adapted for allowing the wetted fiber to exit the housing.

### FIELD

The present invention is related to a closed resin impregnation process and an apparatus for closed resin impregnation; and more specifically, to a closed resin impregnation process and apparatus for impregnating a continuous fiber in a closed resin impregnation process for forming fiber composite articles.

### BACKGROUND

Filament winding is a known process in the prior art. For example, Canadian Patent No. CA2006/2535149A1 discloses an apparatus for resin-impregnation of fibers for filament winding and describes a conventional filament winding process which utilizes a resin bath containing resin for impregnating the fibers. The fibers are submerged in the bath and then pass through and from the resin bath to other apparatuses for further handling.

A majority of wet filament winding applications utilize the above conventional filament winding process and resin bath which can also be referred to as a submersion method for resin impregnation of dry fiber filaments. However, a significant drawback to the submersion method is that the reacting chemical system is exposed to the open air which may cause undesired reactions.

Heretofore, there have been some attempts in improving the submersion method for resin impregnation of dry fiber filaments. For example, U.S. Pat. No. 6,387,179B1 discloses a method and device for impregnating fiber bundles with a resin (e.g., epoxy, polyurethane, and the like) utilizing a multi-chambered impregnation head or box. The pressure within the impregnation box is adjusted so that the resin flows upstream against the movement of the fibers and creates a “wall” of resin through which the fibers can pass.

U.S. Patent Application Publication No. US 1998/5766357A1 discloses an apparatus and a method for resin impregnation into fiber bundles through the use of a manifold with individual grooves for each fiber. The manifold has channels for the resin to flow through and wet the fiber bundles. A control system measures and meters the resin flow.

FIG. 1 of JP 2009/126053A shows a resin adhesion apparatus.

U.S. Pat. No. 6,179,945B1 discloses a process and apparatus for filament winding composite work pieces. The process includes using an injection die to impregnate fibers just before the fibers are wound around a composite part. However, the above patent is silent on the design of the injection apparatus or the contents therein.

The aforementioned prior art discloses certain aspects of a resin injection box but does not disclose any details of a resin injection box, how a resin injection box is used in a closed system, or how impregnation is done in a closed system. It would be desirable to provide a process improvement to a filament winding process by eliminating the open bath and replacing the open bath with a closed in-line impregnation device and process.

### SUMMARY

A solution to the problems of the prior art is presented herein and which removes the need for an open resin bath system. For example, the present invention removes the open resin bath and replaces the open resin bath with a resin injection box or device in a closed system. The present invention also includes a process for manufacturing a fiber-reinforced composite article in the closed injection system utilizing a closed impregnation/injection device for impregnating a fiber reinforcement material, such as continuous fibers, with a thermosetting resin composition such as a polyurethane resin or an epoxy resin.

In one embodiment of the present invention, a closed impregnation/injection device for impregnating a fiber reinforcement material with a thermosetting resin composition includes:

(a) a housing;

(b) an entry means disposed in the housing adapted for feeding a dry fiber reinforcement material into the housing of (a);

(c) a means for feeding a dry fiber reinforcement material through, and into, the housing of (a) via the entry means of (b);

(d) a passageway from the entry means of (b) into the housing adapted for allowing the fiber from (b) to enter into the housing of (a);

(e) an injection means disposed in the housing adapted for injecting a thermosetting resin composition into the housing of (a); and contacting and wetting the dry fiber reinforcement material of (b);

(f) a means for feeding a thermosetting resin composition through, and into, the housing of (a) via the injection means of (e);

(g) an exit means disposed in the housing adapted for discharging a wetted fiber reinforcement material from the housing of (a); and

(h) a passageway from the inside of the housing (a) to the outside of the housing adapted for allowing the wetted fiber from (d) to exit the housing of (a).

Another embodiment of the present invention includes a process for injecting a thermosetting resin into a fiber reinforcement material using the above closed impregnation/injection device.

Still other embodiments of the present invention includes a filament winding apparatus and process for manufacturing a cured fiber reinforced composite article using the above closed impregnation/injection device.

### BRIEF DESCRIPTION OF THE DRAWINGS

For the purpose of illustrating the present invention, the drawings show a form of the present invention which is presently preferred. However, it should be understood that the present invention is not limited to the precise arrangements and instrumentation shown in the drawings. In the drawings, like elements are referenced with like numerals. Therefore, the following drawings illustrate non-limiting embodiments of the present invention wherein:

FIG. 1 is a general schematic flow diagram showing a filament winding process including a closed impregnation/injection device for impregnating a fiber reinforcement material with a thermosetting resin composition of the present invention.

FIG. 2 is a cross-sectional, partially exploded, view of an in-line a closed impregnation/injection device for impregnating a fiber reinforcement material with a thermosetting resin composition of the present invention.

FIG. 3 is a horizontal cross-sectional view of the impregnation/injection device of the present invention showing the “Entry Region (210)” of FIG. 3.

FIG. 4 is a horizontal cross-sectional view of the impregnation/injection device of the present invention at “Contact Region (220)” of FIG. 3.

FIG. 5 is a horizontal cross-sectional view of the impregnation/injection device of the present invention at “Metering Region (230)” of FIG. 3.

FIG. 6 is a horizontal cross-sectional view of the impregnation/injection device of the present invention at “Exit Region (240)” of FIG. 3.

FIG. 7 is a schematic illustration showing fiber and resin in the impregnation/injection device coming into contact with each other within the device of the present invention.

FIG. 8 is a cross-sectional view of pipe member showing a cured thermoset matrix and fiber reinforcing material composite the present invention.

### DETAILED DESCRIPTION

In its broadest scope, the present invention includes a device or apparatus for, and a process for, manufacturing a fiber-reinforced composite article. The process includes a closed fiber impregnation (also referred to as fiber infusion or fiber injection) step, using a closed fiber impregnation device. The closed fiber impregnation device can be used, for example, in-line in a filament winding process.

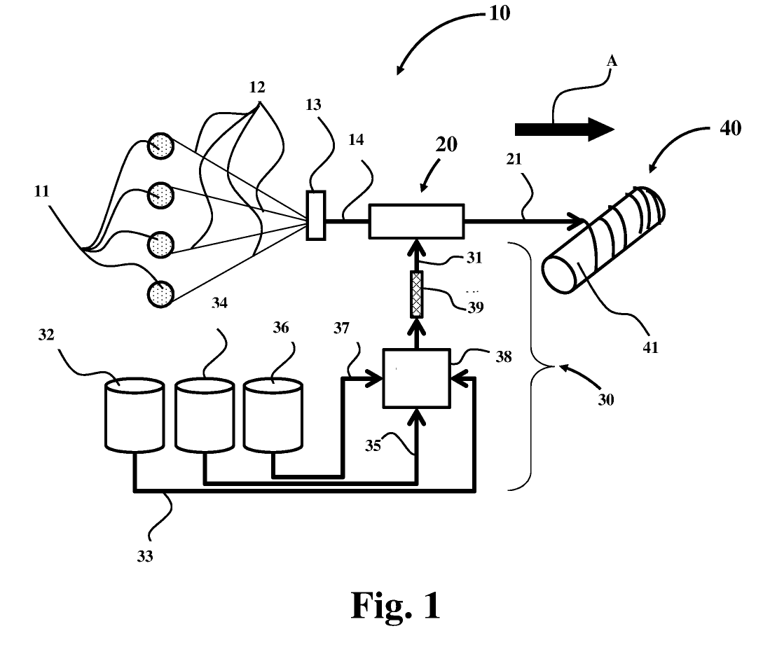

With reference to FIG. 1, there is shown a schematic process flow chart of the present invention equipment and process for dispensing continuous fiber and manufacturing a composite product, generally indicated by numeral 10. The process includes a storage area of spools 11 containing continuous fibers 12 thereon; a guiding member 13 to form a band of fibers 14; a closed fiber impregnation device, generally indicated by numeral 20, into which the fibers 14 are fed; a means of injecting a resin fluid, generally indicated by numeral 30, into the closed fiber impregnation device 20, and a filament winding area including a mandrel 41.

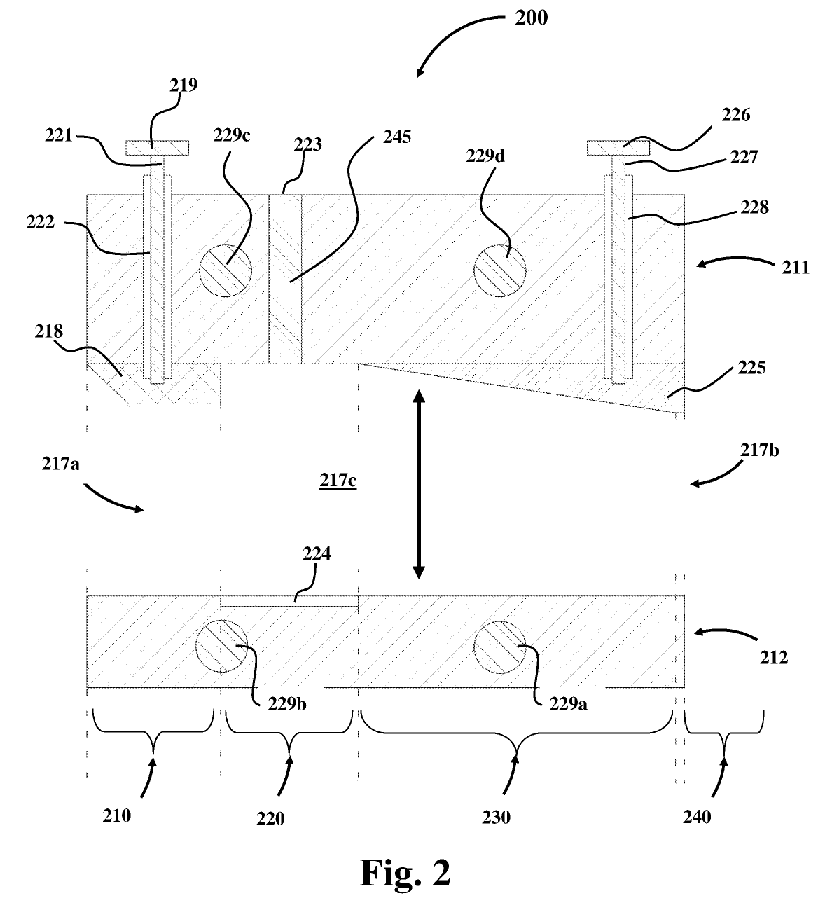

With reference to FIG. 1 again, there is shown fiber rovings 12 coming from spools 11. The fibers can be made of glass fibers, carbon fibers, aramid fibers and the like. The fiber rovings are mounted on creels in the storage area until the fibers are ready for use. In use, the fibers 12 are pulled in the direction indicated by arrow A, gathered together, and collected through a fiber guide (or “comb”) 13. The number of the fibers 12 brought together determines the band width of the fibers 14 fed into the device 20. The fibers 12 are pulled through the comb 13 forming a band of fibers 14, which are pulled through the closed fiber impregnation device 20 which may be heated. The fibers 14 are pulled through the closed fiber impregnation device 20 and exit the device as resin impregnated fiber-reinforced composite fibers 21. One preferred embodiment of the impregnation device 20 is shown in FIGS. 2-7 and is described in more detail herein below. The impregnated or wetted fibers 21 exit from the impregnation device 20; and then the wetted fibers 21 exiting from the impregnation device 20, are drawn to a rotating mandrel 41 of a filament winding apparatus. Once the winding of the fibers 21 on the rotating mandrel 41 is complete, the fiber composite article, if not completely cured, can be cured through another heating process (not shown) before manufacturing is considered finished.

In one preferred embodiment, the resin fluid injection means 30 may include any means of combining reactants forming the liquid resin and flowing the resin into the injection device 20. For example, as shown in FIG. 1, two (or more) resin system components are stored separately in storage tanks 32, 34, 36; and then the resin components are combined in a mixing tank 38 to form a reactive mixture. The flow of the resin system components is provided by metering pumps. The metering pumps deliver the correct mix ratio of the resin system to the mixing tank 38 (that may or may not be agitated depending on the system used). The liquid contents of the mixing tank 38 can be sent through a static mixer 39 before the liquid resin is flowed into the impregnation box 20 to deposit the reactive resin mixture into a fiber bundle 14 being pulled through the impregnation box 20 of the process. Optionally, the separately stored reactants forming the liquid resin may be combined directly in the static mixer 39. The mixing tank 38 can be pressurized with an inert gas to facilitate homogenous impregnation of the resin system into the fiber bundle. Any excess resin is removed and discarded. The present invention provides an efficient design of the equipment for the filament winding process and an improved filament winding process.

With reference to FIGS. 2-7, there is shown several cross-sectional views of an in-line impregnation device of the present invention, generally indicated by numeral 200. The impregnation device 200 is only one embodiment of the impregnation device and other modifications falling within the scope of the present invention may be readily made by those skilled art. The impregnation device of the present invention is useful for homogenously impregnated/distributing a liquid polymer resin into and throughout a continuous fiber bundle passing through the impregnation device 200.

Generally, the closed impregnation device 200 for processing a continuous filament reinforced composite includes four regions: (1) an entry region 210 of constant cross-section, said entry adapted for allowing dry fiber reinforcing material to enter into the device and a separate entry region for feeding a mixed polymer system into the device; (2) a contact region 220 of constant cross-section where the mixed polymer system and dry fiber tows contact one another; (3) a metering region 230 with a converging cross section; and (4) an exit region 240 with a constant cross-section to allow the resin impregnated fibers to exit the device.

As shown in FIG. 2, the device 200 includes a top half generally indicated by numeral 211; and a bottom half generally indicated by numeral 212. The top half 211 and the bottom half 212 can be detached from each another as shown in the partially exploded view of FIG. 2. In addition, the device 200 comprising four zones, regions or sections: (1) an entry section, generally indicated by numeral 210, (2) a contact section, generally indicated by numeral 220, (3) a metering section, generally indicated by numeral 230, and (4) a discharge or exit section, generally indicated by numeral 240. Other embodiments of the device 200 can include additional zones if desired.

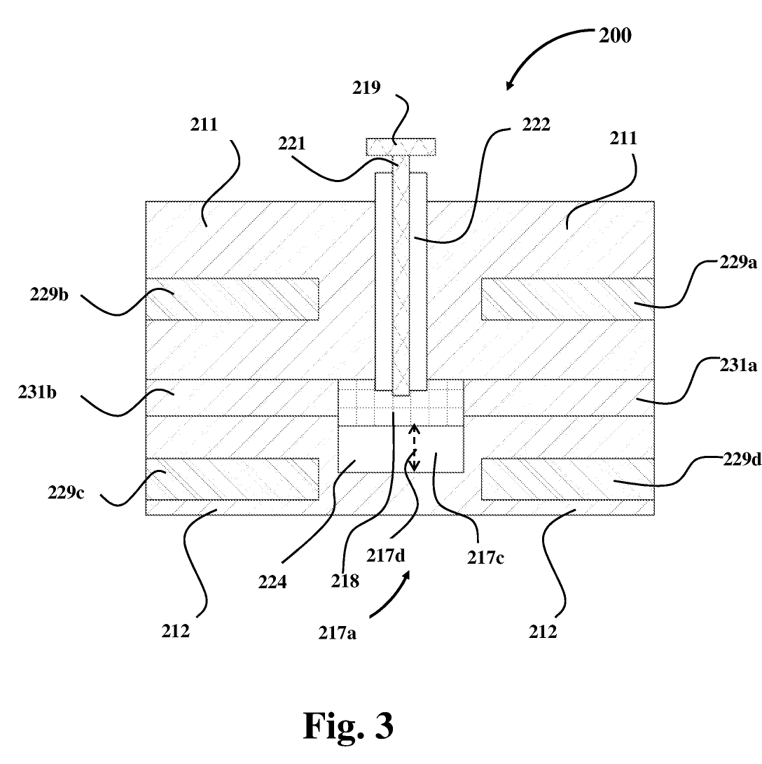

When the device 200 is in use, fibers enter the unit or device 200 through an opening generally indicated by numeral 217a of the unit; pass through the device 200 via a channel 217c; and then the fibers exits the device 200 through an exit opening generally indicated by numeral 217b of the unit. The opening 217a and the channel 217c with a predetermined gap shown as dotted line 217d is formed when the top 211 and bottom 212 sections of the device 200 are in contact with each other as shown in FIG. 3. The thickness of the entering fiber can be adjusted with the use of a vertically movable wedge 218. The wedge 218 is adjusted through the rotation of a control knob 219 that is attached to a male threaded pin 221 which in turn is disposed in a female threaded chamber 222. The fibers then move from the entry section 210 to the contact section 220 via channel 217c. Liquid is fed through a machined port 223 and allowed to flow into the contact region 220 and come into contact with the continuous rovings moving through the channel 217c at the gap height 217d. In a space 224 after passing through the opening 217a, the liquid is allowed to build in order to achieve an even coating of the fibers. The wetted fibers move from the contact region 220 to the metering region 230 where the vertical dimension of the gap 217e decreases linearly through the use of a vertically adjustable gap wedge 225. The wedge gap 225 is controlled through a knob 226 that is attached to a male threaded pin 227 which in turn is disposed in a female threaded chamber 228. Cartridge heating elements 229a, 229b, 229c and 229d are optionally added to the impregnation device 200 to control the temperature of the device. The temperature of the device 200 can be from about room temperature to about 150° C. in one embodiment; from about room temperature to about 110° C. in another embodiment, and from about room temperature to about 70° C. in still another embodiment. The temperature of the impregnation device is to control the reactivity of the polymer that is being fed into machined port 223. Too high of a temperature in the impregnation device will advance the polymerization too quickly leading to a undesirable viscosity increase. This undesired viscosity increase can adversely affect quality of fiber wet-out and lead to gelling and fouling of the impregnation device.

With reference to FIG. 3, there is shown a horizontal cross sectional view of the device 200 at the entry region 210 of the device shown in FIG. 2. The entry region 210 is shown in FIG. 3 with the top half 211 of the device 200 connected to the bottom half 212 of the device 200. Side walls 231a and 231b forms the channel 217c with gap (217d) through which the fibers travel. The fibers enter and are contained in the channel 217c. The entry channel gap height 217d can be adjusted through the use of the entry wedge 218. The wedge gap is controlled through the knob 219 that is attached to the male threaded pin 221 which is disposed in the female threaded chamber 222. Also shown in FIG. 3 are optional cartridge heating elements 229a, 229b, 229c and 229d which can be disposed in the body of the device 200 in any convenient location.

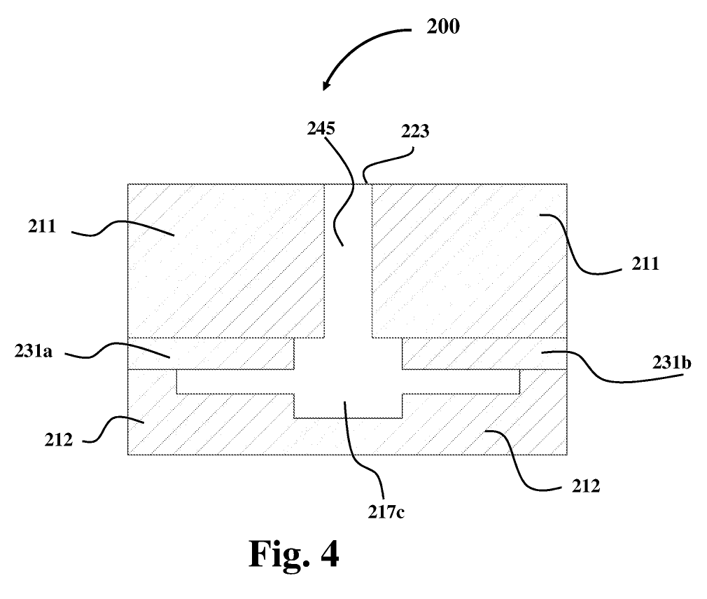

With reference to FIG. 4, there is shown a horizontal cross sectional view of the device 200 at the contact region 220 as shown in FIG. 2. The contact region 220 is shown in FIG. 4 with the top half 211 of the device connected to the bottom half 212 of the device 200. Device 200 contains side walls (231a and 231b) of the channel (217c) through which the fibers travel there through. The fibers enter and are contained in the channel 217c. Liquid resin enters the channel through port 223 and channel 245 to contact the fibers in channel 217c. Optionally, the device at the contact region 220 can include heating cartridges (not shown); and, the optional heating cartridges used in this embodiment of the device can be similar to the cartridges 229a, 229b, 229c and 229d, shown in FIG. 3.

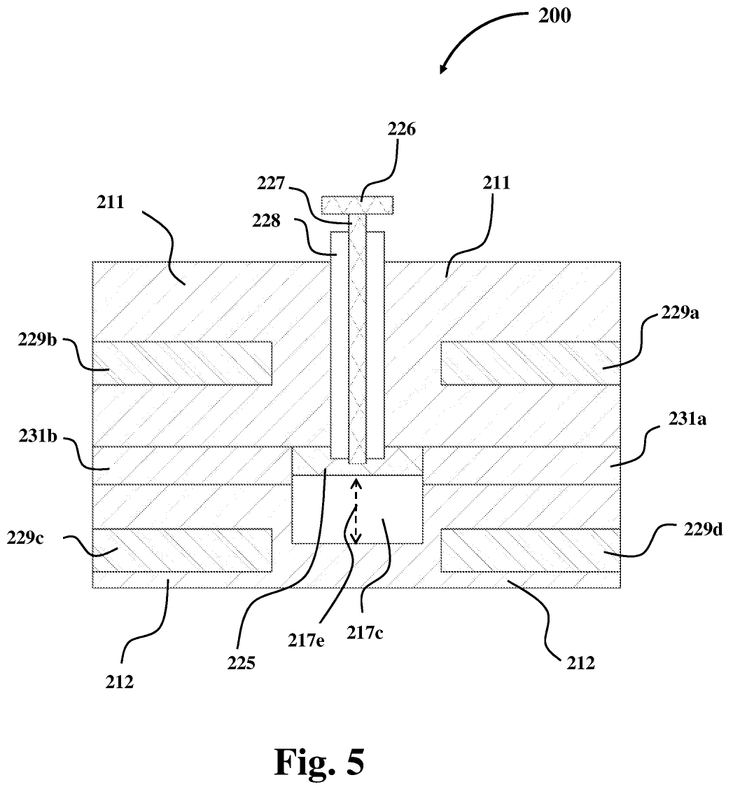

With reference to FIG. 5, there is shown a horizontal cross sectional view of the device 200 at the metering region 230 as shown in FIG. 2. The metering region 230 is shown in FIG. 5 with the top half 211 of the device 200 connected to the bottom half 212 of the device 200 forming channel 217c with a gap height 217e. Additionally, the device has side walls 231a and 231b of the channel (217c) through which the fibers travel. In FIG. 5, the fibers are moving in a direction which is into and out of the horizontal plane of FIG. 5, i.e., in a perpendicular direction to the plane of the cross-sectional view of the device 200. The channel 217c is the same channel that the fibers have been in the device since entry into the device 200. The metering gap height 217e can be adjusted through the use of a wedge 225. The wedge gap is controlled through the knob 226 that is attached to the male threaded pin 227 which in turn is disposed in the female threaded chamber 228. The heating cartridges 229a, 229b, 229c and 229d can be used in the device 200 as shown in FIG. 5.

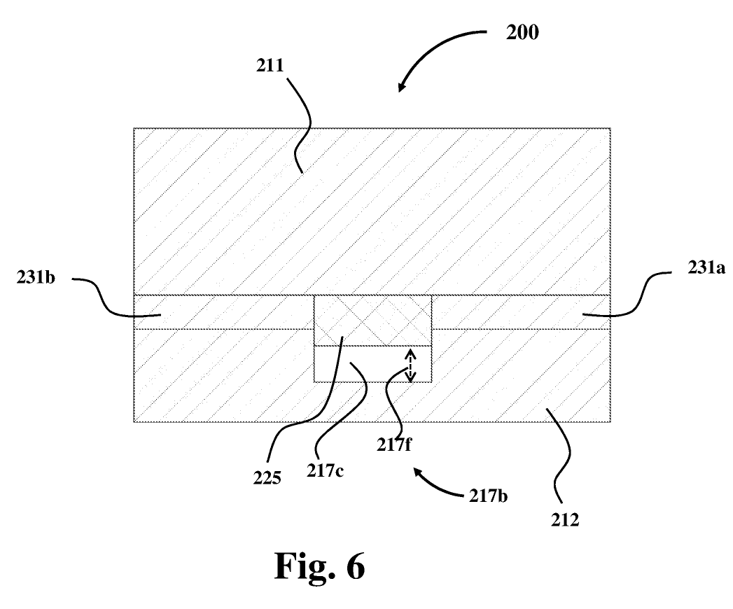

With reference to FIG. 6, there is shown a horizontal cross sectional view of the device 200 at the exit region 240 as shown in FIG. 2. The exit region 240 is shown in FIG. 6 with the top half 211 of the device connected to the bottom half 212 of the device 200 forming the channel 217c with a gap height shown as dotted line 217f. FIG. 6 shows side walls 231a and 231b of the channel 217c through which the fibers travel and exit the device 200. The exit channel gap height 217f is controlled through the use of a wedge (225 of FIG. 5). In summary, the fibers enter the impregnation device 200 through entry 217a as shown in FIG. 3 and exit the device 200 through exit opening 217b as shown in FIG. 6.

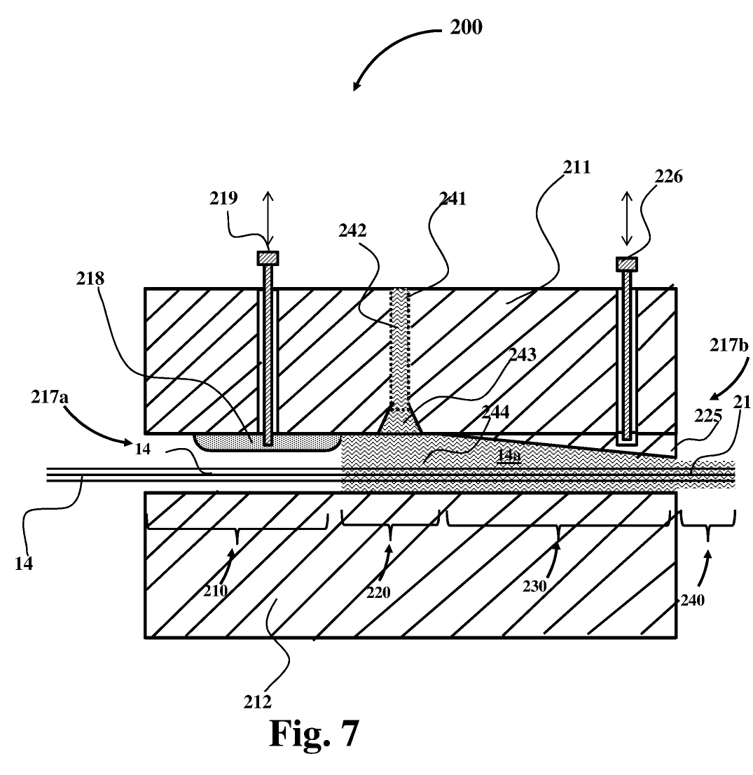

With reference to FIG. 7, there is shown a horizontal cross sectional view of the device 200 with resin polymer 244 being metered into the device 200 via channel 242 to impregnate the dry fiber reinforcement material 14 being fed into the device 200 via entrance opening 217a. In the entry region 210, the dry fibers 14 enter the device 200 and pass to the contacting region 220 where resin contacts the fibers. Then, the resin 244 wets the fibers 14 until the fibers are substantially wetted with the resin throughout the fibers as the wetted fibers 14a pass through the metering region 230 of the device 200. The substantially impregnated fibers 21 exit the device 200 via exit opening 217b at the exit region 240 as shown in FIG. 7; and the impregnated fibers 21 are then sent to a filament winding mandrel 41 (not shown in FIG. 7, but shown in FIG. 1). Optionally, the impregnated fibers 21 can be heated further in a heating apparatus such as an oven (not shown) before the impregnated fibers 21 are wound on the mandrel 41. The post-injection heating can be used to ensure complete curing of the resin impregnated fibers before the fibers are wound.

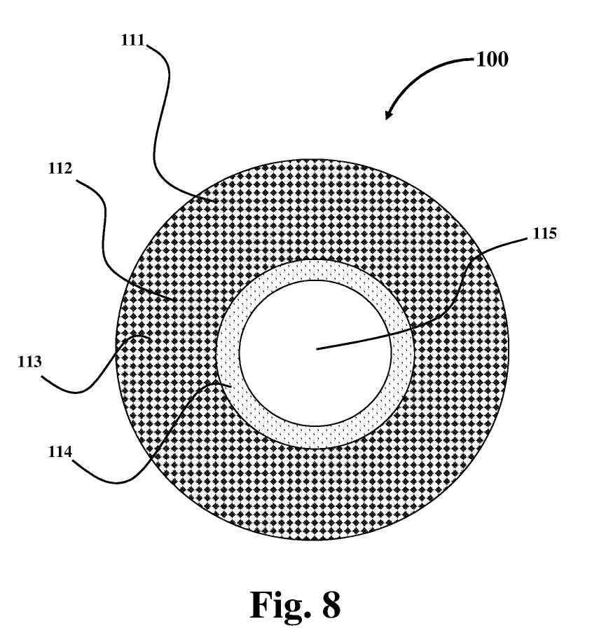

After the impregnated fibers 21 are wound on the mandrel 41, and the wound article is heated to completely cure, the cured wound composite article can be removed from the mandrel 41 and cut to any desired or predetermined length. With reference to FIG. 8, there is shown a cured fiber-reinforced composite article, in this case, a pipe article generally indicated by numeral 100. The cylindrical pipe structure 100 includes a wound composite layer 111 comprising a cured resin polymer matrix 112 and glass fiber reinforcing material 113. The wound composite pipe structure 100 is shown on a mandrel 114 of the filament winding apparatus. The interior space of the mandrel is indicated by numeral 115.

The process for impregnating a continuous filament reinforced composite generally includes: (a) introducing dry fiber tows into the injection device, wherein the fiber tows have a constant cross-section; (b) introducing a polymer resin system into the injection device; (c) contacting the polymer resin system with the dry fiber tows inside the injection device; (d) metering the resin system into the injection device to coat and impregnate the dry fiber tows for a sufficient time to wet the fibers inside the device to form wetted fibers; (e) withdrawing wetted fiber tows impregnated with the polymer resin system from the device. The continuous fibers are pulled through the impregnation device using a pulling means of the filament winding process; and the fibers are contacted with the reaction mixture in the impregnation device for a time period and at a temperature sufficient to cause begin polymerization of the reaction mixture within the impregnation device and continuing the polymerization of the reaction mixture to produce a composite of fibers coated by the reaction mixture. The polymerization is carried to form a partially cured composition or gel or a substantially cured composition depending on a particular processing need. The composite of coated fibers may be passed through a heated curing apparatus to at least partially further advance the cure of the reaction mixture to produce a gelled material/fiber composite or to produce a solid fiber reinforced polymer matrix. The gelling can take place at from about 10 seconds to about 500 seconds; and the solid composite can be drawn from the curing means, wherein the reaction mixture cures between about 100 seconds and about 1,000 seconds at 60° C.

Another broad aspect of the present invention is directed to a process for closed impregnation of continuous fibers and processing the continuous fibers to prepare a fiber composite including the steps of: (I) providing a dry fiber tow; (II) providing a polymer resin system; (III) providing the closed impregnation device 200; (IV) passing the polymer resin system and the dry fiber tow in contact with each other through the closed impregnation device 200; (V) passing the impregnated fiber from the closed device 200 to a roller member or a mandrel of a filament winding unit; and (VI) heating the impregnated fiber to form a fiber-reinforced composite article.

One preferred embodiment of the present invention process includes the closed fiber impregnation device or apparatus 200 described above incorporated into a filament winding process for manufacturing a fiber-reinforced composite article. With reference to FIG. 7 again, there is shown a closed fiber impregnation device 200 of the present invention with fiber continuous fibers, tows or rovings 14 and liquid resin 244 in contact within the interior of the device 200. FIG. 7 shows fiber rovings already gathered together and collected through a fiber guide (not shown in FIG. 7 but shown in FIG. 1 as 13) to form a band width of fibers. The dry band of fibers 14 move through the device 200 as the resin flows into and through the device 200 in contact with the fibers 14 to form wet impregnated fiber 14a until the impregnated fibers 21 exit the injection device 200. The fibers are pulled through the closed fiber impregnation device 200 with a pulling apparatus and mechanism (not shown). The impregnated fibers 21 exit from the impregnation device 200; and then the wetted fibers 21 exiting from the impregnation device 200 are drawn to the filament winding zone 40 (See FIG. 1) which includes a rotating mandrel 41 of a filament winding apparatus (not shown); and the resin impregnated fibers can then be prepared for forming a fiber composite article by curing through another heating process (not shown) to complete the manufacturing of the fiber-reinforced composite article.

In one broad preferred embodiment of processing the continuous fibers to manufacture a fiber-reinforced composite article includes the contacting the fibers with a resin composition inside an injection box or device. More specifically, the process includes admixing components to make the reactive resin system such as (i) a polymer resin, and (ii) a curing agent for curing the polymer resin; and providing (iii) a fiber reinforcement material to be impregnated with the reactive system. The admixing of the compounds or components to make the polymer resin system can be carried at a mixing rate of generally from about 0.001 grams per second to about 10,000 grams per second in one embodiment, from about 0.01 grams per second to about 1,000 grams per second in another embodiment, and from about 0.1 grams per second to about 100 grams per second in still another embodiment. The goal in the admixing step is to meter the mixed resin system at the exact speed at which the fiber is being pulled through the injection chamber (200).

The reactive mixture can be processed under process conditions for forming a resin system suitable for impregnating the fibers. For example, the components of the resin system can be heated at a predetermined temperature before, during or after injecting into the injection box. The temperature of heating can generally be in the range of from about room temperature to about 150° C. in one embodiment, from about room temperature to about 125° C. in another embodiment, and from about room temperature to about 100° C. in still another embodiment. In general, once the reactants are mixed, for example, in a static mixer, the reactive mixture immediately begins curing at the curing temperature upon leaving the impregnation device. There is no need for a residence time other than the time from initial mixing of the two or more component system to the time the system leaves the impregnation chamber. In another alternative embodiment, an intermediate “pot” or mixing vessel may be used for mixing the reactants such that the reactants are mixed for a predetermined residence time before entering the impregnation device.

The process of the present invention for preparing the resin system may be a batch process, an intermittent process, or a continuous process using equipment well known to those skilled in the art.

The resin system may be comprised of any thermosetting reactive polymer mixture including, but not limited to, epoxy-based, polyurethane-based, vinyl ester-based, polyester-based and phenolic-based resin systems or any advantageous combination thereof. For example, thermosetting liquid resins that may be useful in the present invention may be selected from one or more of resins described in U.S. Pat. Nos. 4,604,435 A and 4,663,397 A, both patents which are incorporated herein by reference.

The fibrous material useful in the present invention may be comprised of any known reinforcing material including but not limited, to carbon, glass, aramid or natural fibers or any combination that is advantageous. For example, fiber materials that may be useful in the present invention may be selected from one or more of fiber materials described in U.S. Pat. Nos. 4,460,639A, 4,818,448A, 3,571,901A and 3,971,669A; DE102004054228A1; and EP0671259A1, all of which are incorporated herein by reference.

With reference to FIG. 8, there is shown a composite article, in this case a pipe structure, generally indicated by numeral 100. The cylindrical pipe structure 100 includes a wound composite layer 111 comprising a cured resin polymer matrix 112 and glass fiber reinforcing material 113. The wound composite pipe structure 100 is shown on a mandrel 114 of the filament winding apparatus. The interior space of the mandrel is indicated by numeral 115.

The size of the composite article of the present invention is not limited; and may depend on the final application of the part and what the specific requirements are for such part used in a particular application. The thickness of the wound composite article 100 can be generally from about 1 millimeter (mm) to about 1,000 mm in one embodiment, from about 5 mm to about 750 mm in another embodiment, and from about 10 mm to about 500 mm in still another embodiment.

The number of layers that the composite article of the present invention can include is not limited; and may depend on the final application of the part and what the specific requirements are for such part used in a particular application. The structure 100 of FIG. 8 is shown as a fiber-reinforced composite with one layer. However, the number of layers for the structure 100 is not limited to one and can be any number of layers to make up an overall multi-layer structure. For example the number of layers can be generally from about 1 layer to about 100 layers in one embodiment, from about 2 layers to about 75 layers in another embodiment, and from about 3 layers to about 60 layers in still another embodiment.

### EXAMPLES

The following examples and comparative examples further illustrate the present invention in more detail but are not to be construed to limit the scope thereof.

In the following Examples, various materials, terms and designations are used and are explained as follows:

VORAFORCE™ TW 103 is a formulated epoxy resin having an EEW of 179 and commercially available from The Dow Chemical Company.

VORAFORCE™ TW 152 is a formulated anhydride curing agent with a hydrogen equivalent weight (HEW) of 170 and commercially available from The Dow Chemical Company.

VORANOL 220-060 is a polyether polyol with an average functionality of 2.0 and an OH number of 260 and commercially available from The Dow Chemical Company.

VORAFORCE™ TW 1200 is a polymeric methylene diphenyl diisocyanate (pMDI) with a 131.5 equivalent weight and 32.0% NCO content and commercially available from The Dow Chemical Company.

General Procedure of Filament Winding Process

A composite pipe was manufactured using a filament winding process. Filament winding is one of the more important composite production methods in terms of number of users and total number of fabricated parts. The filament winding process begins with fiber tows coming from spools of glass or carbon fibers mounted on a creel. The fibers are gathered together and collected through a type of fiber guide (i.e., a “comb”) to form a band. The number of the fibers brought together determines the band width. The band is pulled through a resin bath (containing a resin and a hardener mixed together such that the system is active). The resin from the resin bath impregnates the pulled fiber tow. The fibers are then drawn through a roller or wiper system to achieve the desired resin content on the fibers; and then the fibers are drawn through a payoff. The “payoff” is the point at which the fiber contacts a moving carriage and directs the fibers on to a rotating mandrel. This method of production is efficient for producing any type of cylindrical part. Furthermore, as the complexity and capability of filament winding machines increases, other non-cylindrical parts can also be wound using a filament winding method.

### Example 1

### Closed Impregnation of an Epoxy-Based System for Filament Winding

Part A: General Procedure for Preparing the Resin Composition

An epoxy-based resin system was used to form a composite article through filament winding. The epoxy resin (“A side”) used was a bisphenol-A-based epoxy resin (VORAFORCE™103) with an epoxide equivalent weight (EEW) of ˜171. The hardener chosen (“B-side”) was a methyl tetrahydrophthalic anhydride-based hardener (VORAFORCE™ 152) with a hydrogen equivalent (HEW) weight of ˜170. The system was metered into the mixing unit at a ratio of 100 parts of resin to 102 parts of hardener at a mass flow rate of ˜0.32 grams of mixed resin system per second.

Part B: The Fibers Used

Continuous glass fiber reinforcement were stored in creels and used in the present example. The continuous fibers were pulled from their stored state into a guiding frame. The frame may either consolidate or keep separate the continuous reinforcement. The reinforcement was then drawn through a heated injection device to impregnate the fibers with the liquid polymer resin composition described above in Part A. The speed of the continuous reinforcement throughput was an average of 15.25 meters per minute (MPM) which was sufficient to provide a residence time within the injection device of ˜2.5 seconds; which in turn, was sufficient to thoroughly impregnate the fibers.

Part C: General Procedure for Preparing Pipe Composite Structure

A pipe member was wound by winding the impregnated fibers described in Part B above onto a mandrel of a filament winding apparatus. The impregnated fibers completely cure as they are wound on the mandrel. The reinforcement/composition system was filament wound around the mandrel to build up a composite thickness of 15 millimeters (mm). The pipe member was allowed to cure at 80° C. for 2 hours and then cured post-winding at 150° C. for 6 hours to form a pipe product.

### Example 2

### Closed Impregnation of an Epoxy-Based System for Filament Winding

Part A: General Procedure for Preparing the Resin Composition

An epoxy-based resin system was used to form a composite article through filament winding. The epoxy resin (“A side”) used was a bisphenol-A-based epoxy resin (VORAFORCE™ TW 103) with an epoxide equivalent weight (EEW) of ˜171. The hardener chosen (“B-side”) was isophorone diamene (IPDA) with a hydrogen equivalent (HEW) weight of ˜42.5. The system was metered into the mixing unit at a ratio of 100 parts of resin to 25 parts of hardener at a mass flow rate of ˜0.32 grams of mixed resin system per second.

Part B: The Fibers Used

Continuous glass fiber reinforcement were stored in creels and used in the present example. The continuous fibers were pulled from their stored state into a guiding frame. The frame may either consolidate or keep separate the continuous reinforcement. The reinforcement was then drawn through a heated injection device to impregnate the fibers with the liquid polymer resin composition described above in Part A. The speed of the continuous reinforcement throughput was an average of 15.25 meters per minute (MPM) which was sufficient to provide a residence time within the injection device of ˜2.5 seconds which in turn, was sufficient to thoroughly impregnate the fibers.

Part C: General Procedure for Preparing Pipe Composite Structure

A pipe member was wound by winding the impregnated fibers described in Part B above onto a mandrel of a filament winding apparatus. The impregnated fibers completely cure as they are wound on the mandrel. The reinforcement/composition system was filament wound around the mandrel to build up a composite thickness of 15 mm. The pipe member was allowed to cure at 80° C. for 2 hours and then cured post-winding at 150° C. for 6 hours to form a pipe product.

### Example 3

### Closed Impregnation of an Polyurethane Based System for Filament Winding

Part A: General Procedure for Preparing the Resin Composition

A polyurethane-based resin system was used to form a composite article through filament winding. The polyol side (“A side”) used was a castor oil and VORANOL 220-060 based polyol. The hardener chosen (“B-side”) was a polymeric methylene diphenyl diisocyanate (pMDI) (VORAFORCE™ TW 1200). The isocyanate index for the system was 110 and had a mix ratio of 100 parts of polyol to 116 parts isocyanate. The system was metered into the mixing unit at the specified ratio at a mass flow rate of ˜0.32 grams of mixed resin system per second.

Part B: The Fibers Used

Continuous glass fiber reinforcement were stored in rolls creels and used in the present example. The continuous fibers were pulled from their stored state into a guiding frame. The frame may either consolidate or keep separate the continuous reinforcement. The reinforcement was then drawn through a heated injection device to impregnate the fibers with the liquid polymer resin composition described above in Part A. The speed of the continuous reinforcement throughput was an average of 15.25 meters per minute (MPM) which was sufficient to provide a residence time within the injection device of ˜2.5 seconds, which in turn, was sufficient to thoroughly impregnate the fibers.

Part C: General Procedure for Preparing Pipe Composite Structure

A pipe member was wound by winding the impregnated fibers described in Part B above onto a mandrel of a filament winding apparatus. The impregnated fibers completely cure as they are wound on the mandrel. The reinforcement/composition system was filament wound around the mandrel to build up a composite thickness of 15 mm The pipe member was allowed to cure at 100° C. for 4 hours.

What is claimed is:

1. A closed impregnation/injection device for impregnating a fiber reinforcement material with a thermosetting resin composition comprising:
(a) a housing;
(b) an entry means disposed in the housing adapted for feeding a dry fiber reinforcement material into the housing;
(c) a means for feeding a dry fiber reinforcement material through, and into, the housing of via the entry means;
(d) a passageway from the entry means into the housing adapted for allowing the dry fiber reinforcement material to enter into the housing;
(e) an injection means disposed in the housing adapted for injecting a thermosetting resin composition into the housing, and for contacting and wetting the dry fiber reinforcement material with the thermosetting resin composition;
(f) a means for feeding a thermosetting resin composition through, and into, the housing via the injection means;
(g) an exit means disposed in the housing adapted for discharging a wetted fiber reinforcement material from the housing wetted with the thermosetting resin composition; and
(h) a passageway from the inside of the housing to the outside of the housing adapted for allowing the wetted fiber reinforcement material to exit the housing.

2. The device of claim 1, wherein the entry means of the dry fiber reinforcement material and exit means wetted fiber reinforcement material has an adjustable entry gap height.

3. The device of claim 1, wherein the entry means and exit means of the thermosetting resin composition has an adjustable entry gap height.

4. The device of claim 1, including further a means for heating the device.

5. The device of claim 1, wherein the device is adapted for being disassembled into two or more parts.

6. A process for injecting a thermosetting resin into a fiber reinforcement material comprising using the closed impregnation/injection device of claim 1, the process comprising:
(a) feeding the dry fiber reinforcement material into the housing;
(b) passing the dry fiber reinforcement material through the housing;
(c) injecting the thermosetting resin composition into the housing;
(d) passing the thermosetting resin composition through the housing;
(e) contacting the dry fiber reinforcement material passing through the housing with the thermosetting resin composition for a predetermined time and predetermined temperature in the housing such that the thermosetting resin composition impregnates the dry fiber reinforcement material to substantially wet the dry fiber reinforcement material passing through the housing with thermosetting resin composition; and
(f) discharging the wetted fiber reinforcement material from the inside of the housing to the outside of the housing.

7. A filament winding apparatus for manufacturing a cured fiber reinforced composite article comprising the closed impregnation/injection device of claim 1, the apparatus comprising:
(I) a means for passing the dry fiber reinforcement material from a plurality of spools to the closed impregnation/injection device for impregnating the dry fiber reinforcement material to form the wetted fiber reinforcement material;
(II) a means for pulling the wetted fiber reinforcement material to a mandrel of a filament winding apparatus;
(III) a filament winding mandrel for winding the wetted fiber reinforcement material onto the mandrel to form wound impregnated fiber reinforcement; and
(IV) a means for curing the wound impregnated fiber reinforcement to form the cured fiber reinforced composite article.

8. A filament winding process for manufacturing a cured fiber reinforced composite article using the closed impregnation/injection device of claim 1, the process comprising:
(A) providing the dry fiber reinforcement material on a plurality of spools;
(B) providing the thermosetting resin composition;
(C) providing the closed impregnation/injection device:
(D) feeding the dry fiber reinforcement material to the closed impregnation/injection device;
(E) feeding the curable reactive resin polymer composition to the closed impregnation/injection device;
(F) contacting the dry fiber reinforcement material with the thermosetting resin composition in the closed impregnation/injection device for a time and temperature in the closed impregnation/injection device such that the thermosetting resin composition impregnates the dry fiber reinforcement material to substantially wet the dry fiber reinforcement material to form the wetted fiber reinforcement material;
(G) pulling the wetted fiber reinforcement material from the closed impregnation/injection device to a mandrel of a filament winding apparatus;
(H) winding the wetted fiber reinforcement material on the mandrel to form wound impregnated fiber reinforcement; and
(I) curing the wound impregnated fiber reinforcement to form the cured fiber reinforced composite article.

9. The process of claim 8, wherein the thermosetting resin composition is a polyurethane-based resin.

10. The process of claim 8, wherein the dry fiber reinforcement material is a band of continuous fibers.

11. The process of claim 8, wherein the dry fiber reinforcement material is glass, carbon, aramid, or mixtures thereof.

12. The process of claim 8, wherein the temperature of the thermosetting resin composition in contact with the dry fiber reinforcement material in the closed impregnation/injection device is from 23° C. to 150° C.
